(19) United States
(12) Patent Application Publication
(10) Pub. No.: US 2019/0254360 A1
(43) Pub. Date: Aug. 22, 2019

(54) AUTONOMOUS PERSONAL GROOMING APPARATUS, SYSTEM AND METHOD

(71) Applicant: Bader Abdullah Almalki, Cedar Falls, IA (US)

(72) Inventor: Bader Abdullah Almalki, Cedar Falls, IA (US)

(21) Appl. No.: 15/898,628

(22) Filed: Feb. 18, 2018

(51) Int. Cl. A41D 1/00; A61H 7/00; B26B 21/40; A47K 5/14

(52) U.S. Cl. CPC A41D 1/005; A61H 7/004; A41D 2400/38; A47K 5/14; A61H 2201/5058; B26B 21/4056

(57) ABSTRACT

An autonomous grooming apparatus, system and method employs a computer readable compression garment, scanning apparatus, and computer controllable grooming apparatus to selectively perform hair removal, massage, lotion application, or non-permanent body paint. The apparatus includes a fluid reservoir that holds a different fluid and selectively applies the fluid to the area requiring treatment.

### BACKGROUND

### Field of the Disclosure

The present disclosure is directed toward an apparatus, system and method for personal grooming including hair removal, massage, lotion application, and non-permanent body painting.

### Description of the Related Art

The background description here is provided for the purpose of generally presenting the content of the disclosure. Work of the presently named inventor, to the extent it is described in this background section, as well as aspects of the description which may not otherwise quality as prior art at the time of filing, are neither expressly nor implicitly admitted as prior art against the present invention.

Conventionally, removal of unwanted hair has been performed at home using hand held razors or lasers devices. Alternatively, an individual can manually apply a particular chemical or cream, such as NAIR or NAD'S to remove hair in targeted areas. However this is a monotonous task and relies on the user to approximate the target area. Similarly, personal massage has been performed at home using handheld devices and requires the user to self-administer, depriving the user a fully relaxing experience. Application of non-permanent body paint, such as henna, requires a third party to apply the paint, and relies on the third party to create and implement a design by hand.

As recognized by the present inventor, hair removal, massage, and application of non-permanent paint to the skin can be performed more precisely in while providing a luxurious and a relaxing experience.

### SUMMARY

The foregoing paragraphs have been provided by way of general introduction and are not intended to limit the scope of the appended claims. The described embodiments, together with further advantages, will be better understood by reference to the following detailed description taken in conjunction with the accompanying drawings. Moreover, the present inventor recognized hair removal, massage, and the application of non-permanent body paint does not need to be a chore and can be more accurately performed autonomously.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein:

FIG. 1 is a system level diagram of an Autonomous Personal Grooming Apparatus and System (APGAS) according to an embodiment;

FIG. 2A is a plane view of a compression garment according to an embodiment of the present disclosure;

FIG. 2B is an expanded view of a compression garment grid like structure;

FIG. 2C is a schematic of Signal Generator Circuitry;

FIG. 3 is a system level diagram of an Autonomous Personal Grooming Treatment Device according to an embodiment;

FIG. 4 is a schematic of Treatment Device circuitry;

FIG. 5 is a flow chart of a treatment process performed by an embodiment of the Autonomous Personal Grooming Apparatus and System;

FIG. 6 is a plan view of an exemplary track pattern followed by an Autonomous Personal Grooming Treatment Device;

FIG. 7A is a perspective view of an embodiment of the present disclosure wherein a treatment dispenser being detachably attachable to the autonomous treatment device;

FIG. 7B is a plane view of an embodiment of the present disclosure wherein a treatment dispenser being detachably attachable to the autonomous treatment device;

FIG. 8A is a plane view of another embodiment of the present disclosure wherein a treatment dispenser for hair removal being detachably attachable to the autonomous treatment device;

FIG. 8B is a plane view of another embodiment of the present disclosure wherein another treatment dispenser for hair removal being detachably attachable to the autonomous treatment device;

FIG. 8C is a plane view of another embodiment of the present disclosure wherein a treatment dispenser for massage being detachably attachable to the autonomous treatment device;

FIG. 8D is a plane view of another embodiment of the present disclosure wherein a treatment dispenser for lotion application massage being detachably attachable to the autonomous treatment device;

FIG. 8E is a plane view of another embodiment of the present disclosure wherein a treatment dispenser for non-permanent body painting being detachably attachable to the autonomous treatment device;

FIGS. 9A and 9B are a Smartphone application flowchart with menu with selection options to control the autonomous treatment system;

FIG. 10 is the Smartphone application Graphical User Interface;

FIG. 11 is a schematic diagram of controller circuitry employed in an exemplary embodiment of the present disclosure;

FIG. 12 is a schematic diagram of a chip set based controller according to an exemplary embodiment of the present disclosure; and

FIG. 13 is a schematic diagram of an exemplary CPU according to one embodiment.

### DETAILED DESCRIPTION OF THE EMBODIMENTS

Referring now to the drawings, wherein like reference numerals designate identical or corresponding parts throughout the several views. Further, as used herein, the words “a”, “an”, and the like generally carry a meaning of “one or more”, unless stated otherwise.

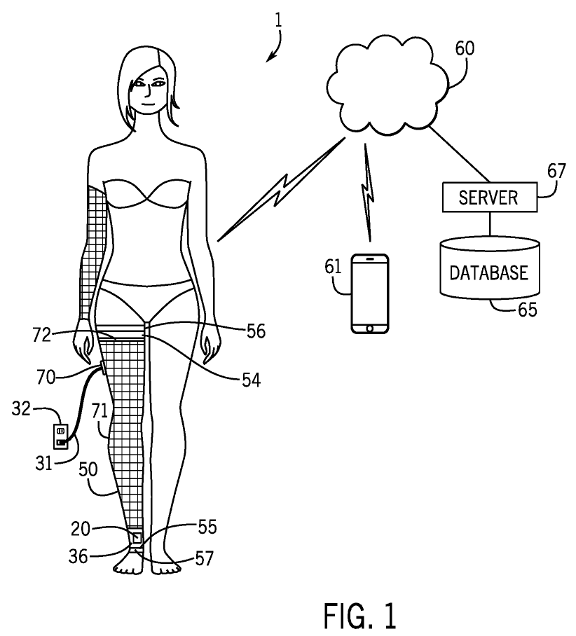

FIG. 1 is a system level diagram of an Autonomous Personal-Grooming Apparatus and System 1 that includes an autonomous treatment device 20, which in the present example is self-driven, according to a self-selected path, a memorized path, a guided path, and/or a programmed path. The autonomous treatment device includes a propulsion and navigation subsystem that moves the device 20 over a portion of the human body while sandwiched between the body and a compression garment 50. The autonomous treatment device 20 hosts a scanner 36 that optically scans (or electrically and/or magnetically scans) data-carrying address lines woven into the compression garment 50. The scanner 36 captures coordinate data from a network of address lines, that run horizontal and vertical in the compression garment 50 so that location information hardware and/or software, configured according to the teachings herein, guide the device 20's propulsion and navigation system.

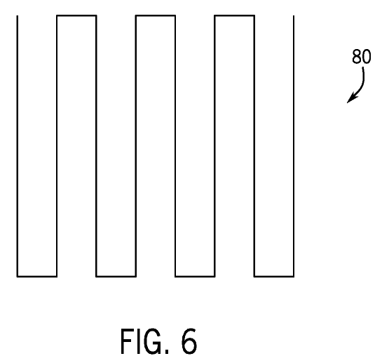

The compression garment 50 hosts computer readable and computer addressable warp threads 51 and computer readable and computer addressable weft threads 52, which in the present example are used to communicate x-axis and y-axis coordinates using its CPU 23 and on-board memory 24, and associates a location stamp (using a detection position in a treatment pattern, or track FIG. 6) in the area being treated. While the term “thread” is used, it is to be understood that thread should be construed in a broad context to include insulated conductive wires, or labeled threads. Alternatively, the autonomous treatment device 20 conveys wirelessly all or a portion of the position data of the device to a remote computer for remote detection and device guidance.

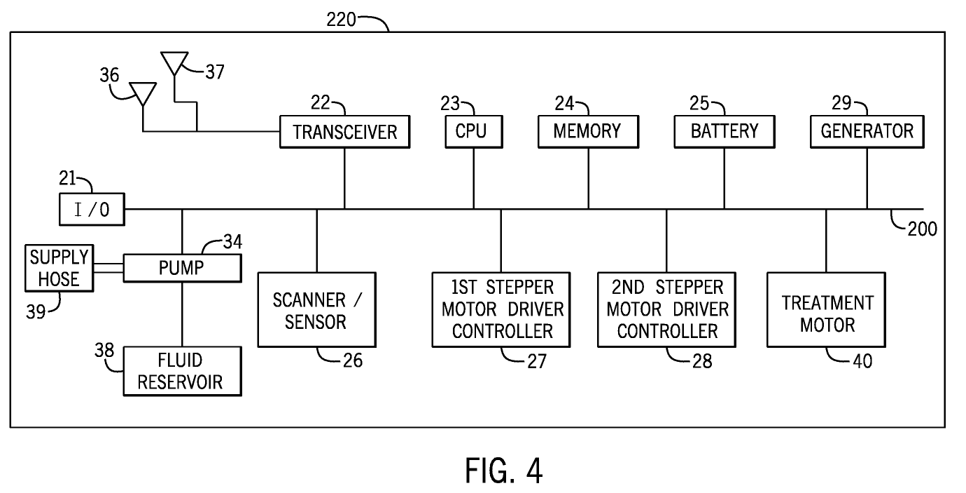

During a first scan of the treatment area data is collected regarding the type and location of treatment to be performed. This data is transmitted wirelessly to a remote computer (server) 67 by way of cellular telephone channel (e.g., as controlled by an app executed on a Smartphone 61) and stored in a remote database 65 via network 60. Alternatively, the data collected is retained in the autonomous treatment device circuitry (FIG. 4), or retained in the Smartphone.

In an example of a hair removal treatment on a leg, the operator of the autonomous personal grooming device 20 inserts a leg to be treated for hair removal into the compression garment 50 suited for a leg shape. The operator secures a top edge 56 of the compression garment 50 with a first elastic band 54 and secures a bottom edge 57 of the compression garment 50 to an opposing side of the leg by a second elastic band 55. The operator inserts a power cord 31 into a wall socket 32 (or battery pack) to provide power to the signal generator circuit 70. The operator starts the treatment process by selecting the ON position of the signal generator circuit switch 33.

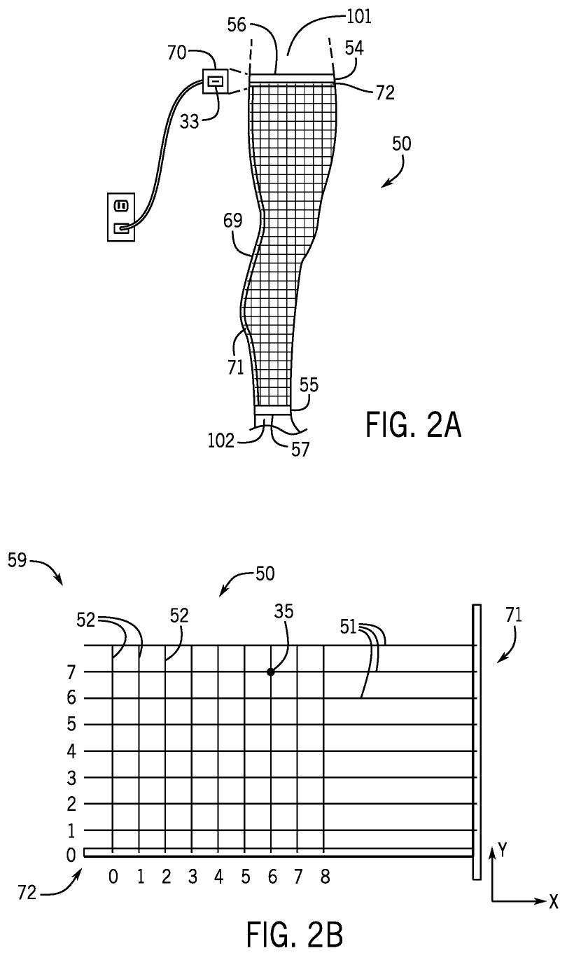

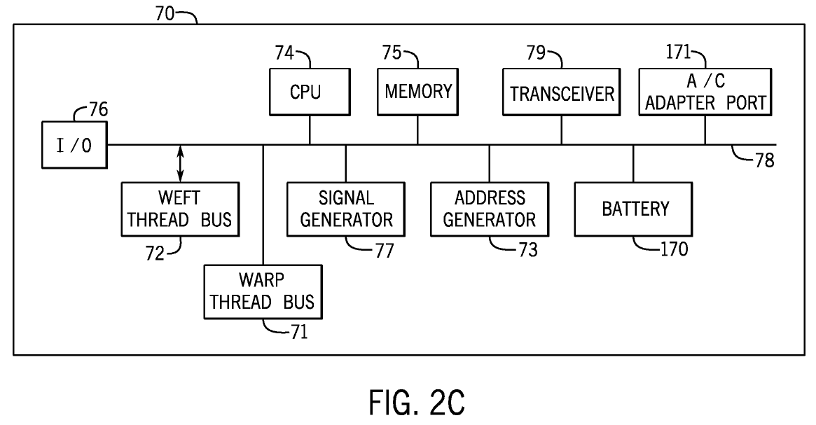

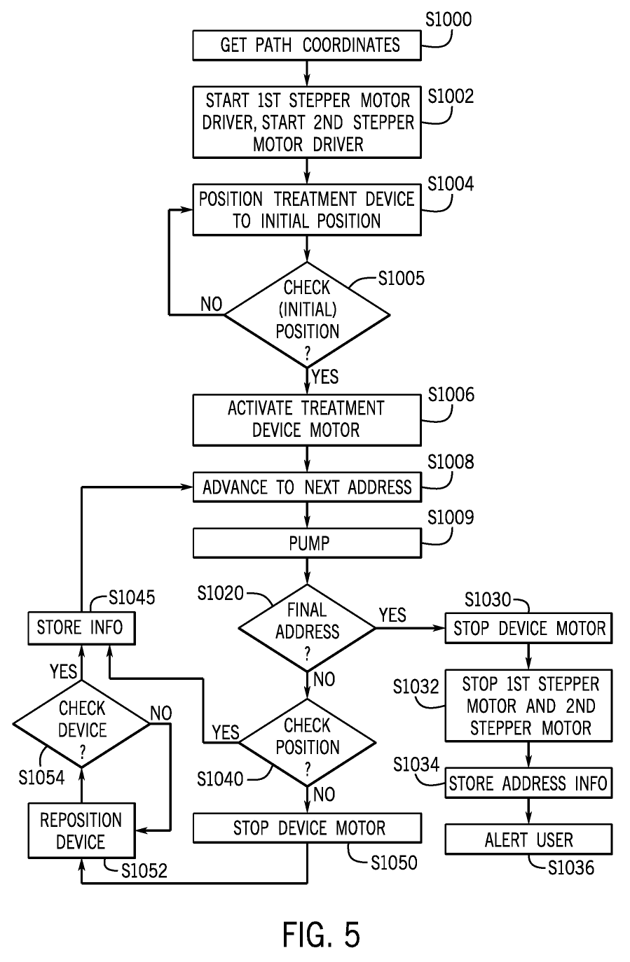

The signal generator circuit 70 generates and assigns unique addresses to each of the warp threads 51 and each of the weft threads 52 and stores these addresses in memory 75 (FIG. 2B). This address information is conducted through the threads and inductively read by the device 20, so a present location of the device 20 is known, and a propulsion direction of the device 20 may be determined. As an alternative the device 20 reads the thread address information via capacitive coupling near field or radio frequency (RF) communication. The information maintained in the signal generator circuit 70 is transmitted wirelessly from the resident memory 75 of the signal generator circuit 70 to a remote computer database 65 (e.g., in a Smartphone) by way of cellular telephone channel. These addresses are used to navigate the autonomous treatment device 20, as described in FIG. 5.

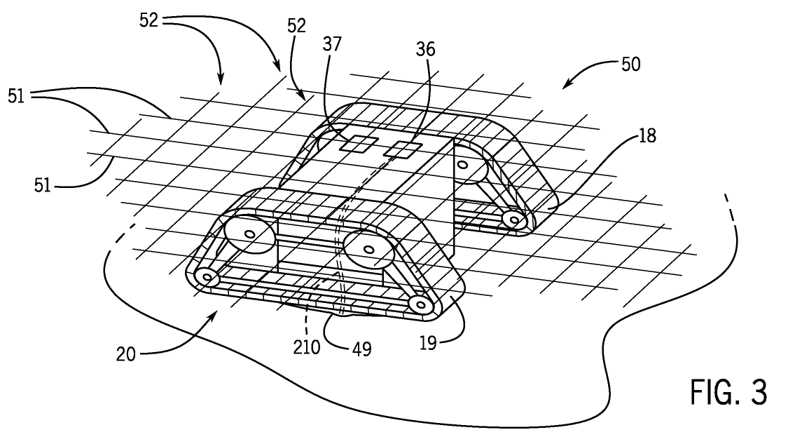

The operator selects the hair removal setting of the autonomous treatment device 20 and selects a pattern for the hair removal treatment wirelessly from a remote computer database 65 by way of cellular telephone channel (e.g., as controlled by and app executed on a Smartphone 61) or from memory 24 retained in the autonomous treatment device circuitry (FIG. 3). The autonomous treatment device 20 is placed between the compression garment 50 and skin of the leg (or other body part) to be treated, such that a hair removal treatment dispenser 49 rests on an initial portion of the treatment area 5 and a scanner/sensor 36 is oriented to rest at an initial position of a Weftₓ₀ thread and a Warp_{y0} thread of the compression garment 50 (FIG. 2 and FIG. 3). The autonomous treatment device is self-propelled along the treatment area as designated by a pre-selected track 80 as described in FIG. 5.

Upon completion of the treatment, the operator stops the treatment process by selecting the OFF position of the switch 33.

FIG. 2A is a plane view of a compression garment 50 according to an embodiment. In the present embodiment the compression garment is wrapped around a leg. The compression garment 50 includes a top edge 56, an opposing bottom edge 57 and a side edge 69. The top edge 56 includes a first elastic band 54 to secure the compression garment 50 to the top of a leg 101, and a Weft Thread Address Bus 72. The opposing bottom edge 57 includes a second elastic band 55 to secure the compression garment 50 to an opposite side of the leg 102. The side edge 69 includes a Warp Thread Address Bus 71

The signal generator circuit 70 is detachably attached to the side edge 69 of the compression garment and includes an On/Off Switch 33. The operator can start or stop the treatment process by moving the power switch 33 of the signal generator circuit 70 to the desired position. The Weft Address Thread Bus 72 and the Warp Address Thread Bus 71 communicate to the signal generator circuit described in FIG. 2C through the input/output port 76.

Each access point on the Weft Thread Address Bus 72 is connected to a single weft thread 52 of the compression garment 50. Each access point of the Weft Thread Address Bus 72 is assigned a unique computer readable Weftₓᵢ address by the CPU 74.

Each access point on the Warp Thread Address Bus 71 is connected to a single warp thread 51 of the compression garment 50. Each access point of the Warp Thread Address Bus is assigned a unique computer readable Warp_{yj} address by the CPU 74.

Each intersection of a unique computer readable Weftₓᵢ and Warp_{yj} generates a unique computer readable address pair 35 as an identifier throughout the compression garment 50, creating the uniquely addressable grid like structure 59.

The compression garment is not limited to the shape of a leg but can be a shirt, pants, sleeves, gloves, socks, bathing suit, etc.

FIG. 2B is an expanded view of a compression garment 50 uniquely addressable grid like structure 59 according to the present disclosure. The compression garment 50 fabric includes weft threads and warp threads spaced apart by a pitch, (e.g. 0.1 mm). Together these threads create a grid structure. The compression garment fabric 50 hosts unique computer addressable weft threads 52 and unique addressable warp threads 51, creating a uniquely addressable grid like structure 59 that wraps around the subject's leg, arms, body (e.g., to shave the subject's back). The Weft Address Thread Bus 72 and the Warp Address Thread Bus 71 communicate to the signal generator circuit described in FIG. 2C through the input/output port 76. The Signal Generator Circuit is described in FIG. 2C.

For illustrative purposes, the weft threads 52 are addressable in the ‘X’ direction by a unique X-address, Weftₓᵢ. Warp threads 51 are addressable in the ‘Y’ direction by a unique Y-address, Warp_{yj}. The intersecting computer addressable pair defined as (Weftₓᵢ, Warp_{yj}). An example computer addressable pair 35 defined as (Weftₓ₆, Warp_{y7}). The computer addressable pair system is used in the navigational algorithm (FIG. 5) to navigate and propel the autonomous treatment device 20 along the path 80. The intersecting computer address pair system (Weftₓᵢ, Warp_{yj}) is communicated to the autonomous personal grooming apparatus and system 1 wirelessly (e.g., inductively, capacitively, or via RF) from the signal generator circuit 70. The intersecting computer address pair system is communicated within the autonomous treatment device 20 via the bus 200 and is communicated externally between the autonomous treatment device 20 and the server 67 via the network 60.

FIG. 2C is a schematic of signal generator circuitry according to an embodiment. In the present embodiment, the signal generator circuitry 70 is dedicated circuitry that interconnects several electronic devices by way of a bus 78. A CPU 74 connects through the bus 78 to a memory 75 and is provided with power from a power source 32. The CPU is a programmable microcontroller, microprocessor, or even an application specific integrated circuit. The CPU 74 performs algorithms associated with the creation, assignment, storage, detection and manipulation of addressable warp and weft threads of the compression garment 50. The CPU 74 also connects through the bus 78 to a transceiver 79 that transmits signal either locally through a Bluetooth connection to the Smartphone 61 or directly to a remote server through a cloud or other wireless network 60 (see FIG. 1). A signal generator 77 sends a unique signal current to each of the warp threads attached to a Warp Thread Address Bus 71 of the compression garment 50 through the I/O 76 device. The signal generator 77 sends a unique signal current (e.g., pulse code modulated waveform) to each of the weft threads attached to a Weft Thread Address Bus 72 of the compression garment 50 through the I/O 76 device. The unique addresses are stored in a resident memory 75 for processing of the resident CPU 74 and are also communicated to the autonomous treatment device circuitry 220 wirelessly. Alternately, an address generator 73 provides discrete, unique numerically assigned numbers, or character addresses to the lines so as to have unique identifiers conveyed electronically down the respective threads. Alternatively, the warp threads and weft threads are marked with unique optical addresses. The unique optical addresses are read by the scanner 26 of the treatment device and transmitted to the CPU 74 for processing. The signal generator circuit 70 includes an A/C adaptor port 171 to provide power to the autonomous treatment device 20. Alternatively, a rechargeable battery 170 provides power to the signal generator circuit 70 and backup power to the treatment device circuitry 220 as needed.

FIG. 3 is a system level diagram of an Autonomous Personal Grooming Treatment Device according to an embodiment.

The autonomous treatment device 20 hosts a first continuous track system 18, a second continuous track system 19, a first stepper motor 27 to advance the first continuous track system 18, a second stepper motor 28 to advance the second continuous track system 19, a pump 34, a fluid reservoir 38, a supply hose 39 to provide fluid (e.g., shaving lotion, moisturizer, non-permanent body paint), a receiver 36 that constantly scans (optically, electrically, magnetically, electromagnetically, and/or capacitively) uniquely addressable warp threads 51 and uniquely addressable weft threads 52 of a compression garment 50 so as to position the autonomous treatment device 20 over the treatment area, using its and on-board memory 24 and associates a location stamp (using a detected position in a treatment pattern, FIG. 6) in the area being treated, and a transmit element (e.g., patch antenna) 37 that constantly transmits the device 20's present location in terms of its current addressable warp thread 51 location and uniquely addressable weft thread 52 location of a compression garment 50. The autonomous treatment device 20 uses its and on-board memory 24 and associates a location stamp (using a transmitted position in a treatment pattern, FIG. 6) in the area being treated. The location stamp may include the uniquely addressable warp thread 51 location and uniquely addressable weft thread 52 location, but also includes a much more accurate position with respect to the treatment pattern that is repeated periodically. In this embodiment the scanner 26 and processors 23 perform the detection. Alternatively, the scanner 26 transmits wirelessly all or a portion of the imagery and position data of the uniquely addressable warp threads 51 and uniquely addressable weft threads 52, to a remote computer for remote detection.

The autonomous treatment device 20 traverses the compression garment 50 using a first stepper motor 27 to advance the first continuous track system 18 and the second stepper motor 28 to advance the second continuous track system 19 along the uniquely addressable grid like structure 59 based a navigational algorithm (FIG. 5). Sharp turns may be executed by one track moving forward and the other moving backward.

A physical connection to the treatment device circuitry 220 is provides via a dedicated conduit 210 for delivering fluids.

The pump 34 is controlled by the CPU 23 and extracts fluid from the fluid reservoir 38 and sends the fluid through the supply hose 39 to the autonomous treatment device 20 exit port 1705.

In an embodiment, the autonomous treatment device 20 provides a shaving treatment and the fluid in the fluid reservoir 38 is a shaving lotion.

In another embodiment, the autonomous treatment device provides a non-permanent body paint and the fluid in the fluid reservoir is a non-permanent body paint (e.g., henna).

In another embodiment, the autonomous treatment device 20 provides a moisturizing treatment and the fluid in the fluid reservoir is a moisturizing fluid.

In another embodiment, the autonomous treatment device 20 provides a massage treatment and the fluid in the fluid reservoir is an oil based fluid.

In the current embodiment, there is a separate autonomous treatment device 20 for each grooming function. In the presently described embodiment, the autonomous treatment device 20 has the treatment dispenser 49 and a razor 42 (passive or electric). In another embodiment the autonomous treatment device 20 has the treatment dispenser being a massager 45. In another embodiment the autonomous treatment device 20 has the treatment dispenser being a lotion dispenser 43. In another embodiment the autonomous treatment device 20 has the treatment dispenser being a non-permanent paint dispenser 44. In another embodiment the autonomous treatment device 20 having the treatment dispenser being a laser 41.

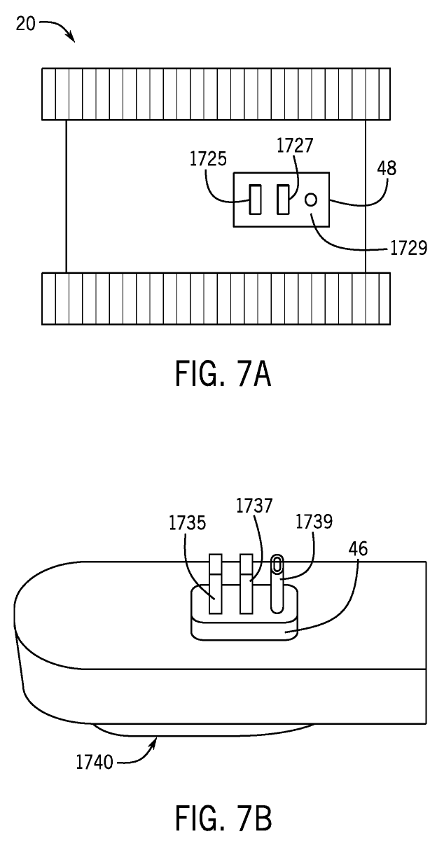

In another embodiment, a treatment dispenser 1740 is detachably attached to the autonomous treatment device 20 (FIG. 7A and FIG. 7B), and each treatment dispenser provides a single grooming function.

FIG. 4 is a schematic diagram of treatment device circuitry according to an embodiment. In the present embodiment the treatment circuitry 220 is dedicated circuitry that interconnects several electronic devices by way of a bus 200. A CPU 23 connects through the bus 200 to a memory 24 and is provided with power from a battery 25. As an alternative, a generator 29 may take electrical current produced by the signal generator circuit 70 and provide power to the treatment circuitry 220 for powering the respective devices and circuitry contained with the treatment circuitry. The CPU 23 as will be discussed is a programmable microcontroller, microprocessor, or even an application specific integrated circuit. The CPU performs the various algorithms as will be discussed in FIG. 5 for example. The CPU also connects through the bus 200 to a transceiver 22 that transmits signals either locally through a Bluetooth connection to the Smartphone 61 or directly to a remote server through a cloud or other wireless network 60 (see FIG. 1).

The scanner/sensor 26 of the treatment circuitry 220 sends and receives information via an I/O port 21 not only wirelessly through the wireless communication network 60, but also through a physical connection to the treatment device circuitry though a dedicated conduit 210, as shown, for delivering fluids.

The receive element 36 of the treatment device 20 is placed in direct contact with the unique computer readable and computer addressable warp threads 51 and unique computer readable and computer addressable weft threads 52 of the compression garment 50. The device 20 also sends and receives information via an I/O port 21 not only wirelessly through the wireless communication network 60, but also through a physical connection.

The transmit element 37 of the treatment device 20 is placed in direct contact with the unique computer readable and computer addressable warp threads 51 and unique computer readable and computer addressable weft threads 52 of the compression garment 50, and sends and receives information via an I/O port 21 not only wirelessly through the wireless communication network 60, but also through a physical connection.

The scanner/sensor 26, the receive element 36, and the transmit element 37 communicate address information to the CPU 23 and CPU 74 for computational analysis of the predetermined path 80 and the real time location of the treatment device 20.

In operation, the receive element 36, and the transmit element 37 exchange information with the CPU which controls the scanner/sensor 26, a first stepper motor 27, a second stepper motor 28, and a treatment motor 40, as provided with power from the battery 25 and/or generator 29. Power from the generator 29 can recharge the battery 25 or provide power to the circuit components in the treatment circuitry 220 for normal operation. The scanner/sensor 36 scans the compression garment 50 for unique weft and warp threads. The CPU receives the scanner/sensor information from the scanner/sensor 26 and performs a match with the detected track 80 addresses saved in memory 24 and in memory 75 so as to determine that the autonomous treatment device 20 is at the particular location of the particular track 80. The location is saved in corresponding memory 24 and in corresponding memory 75. The location information is received continually from the CPU 23 via the I/O port 21 that is either included in the Smartphone 61 which is in proximity to the autonomous treatment device 20 or alternatively included within the transceiver 22. The CPU 23 (using a position detection and path assignment process) continually sends a first path location coordinate to a first stepper motor driver controller 27 and continually sends a second path location coordinate to a second stepper motor driver controller 28.

Real-time location information is transmitted continuously from the receive element 36 and the transmit element 37 via the bus 200 to the CPU 23 for processing. The CPU 23 analyzes this data for comparison to the particular location of the particular track 80. If the real-time location information does not correspond to the particular location of the particular track 80, the treatment is temporarily suspended and the autonomous treatment device 20 is repositioned.

The CPU 23 controls the pump 34. The pump 34 is turned ON during treatment points requiring fluid and is turned OFF during treatment points where no fluid is required, unless treatment is suspended for detection of error real-time-location information. Fluid is extracted from the fluid reservoir 38 and is pumped through the supply hose 39 to the dedicated conduit 210.

The CPU 23 controls the treatment motor 40. The treatment motor is turned ON during the treatment and is turned OFF at the completion of the treatment unless treatment is suspended for detection of error real-time location information.

FIG. 5 is a flow chart of a treatment process performed by an embodiment of the Autonomous Personal Grooming Apparatus and System CPU 23 (FIG. 4). The process begins in step 1000 where the treatment path 80 coordinates are read into memory and the scanning operation is performed with the scanner 36. The process proceeds to step 1002 where the first stepper motor driver controller 27 is activated and the second stepper motor driver controller 28 is activated. The process proceeds to step 1004 where the treatment device is positioned to the initial coordinate of the treatment path 80. The process proceeds to step 1005 where the process checks to ensure the initial position of the treatment device corresponds to the initial position of the path.

If the initial position does not correspond to the initial position of the treatment path, the process proceeds to step 1004 and the first stepper motor driver controller and the second stepper driver controller are advanced to the initial path address position until the treatment device is in the correct position. The scanner 26 continuously reads the address position of the compression fabric from the receive element 36 location stamp and continuously receives the address position of the transmit element 37 location stamp and transmits that information to the CPU 23. The address position of the treatment device 20 is continuously compared to the address of the treatment path 80 coordinate.

If the initial position of the treatment device 20 corresponds to the treatment path, the process proceeds to step 1006 where the treatment device motor (40) is activated.

The process proceeds to step 1008 where the treatment device advances to the next path address (first stepper motor driver controller 27 and the second stepper motor driver controller 28 are advanced).

The process proceeds to step 1009 where a determination is made if the pump 34 should be activated. If the treatment location requires the release of fluid from the fluid reservoir 38, the pump is activated. If the treatment location does not require the release of fluid from the fluid reservoir 38, the pump is not activated. The process proceeds to step 1020 where the path is checked for final position.

If the final address has not been reached in step 1020, the process proceeds to step 1040 where the treatment device position is compared to the path position. The address identified by the scanner 36 is compared to the next address of the path to determine if the location of the address identified by the scanner 36 is identical to the location address of the path. If the treatment device is in the correct position, the process proceeds to step 1045 and the address location of the scanner 36 is saved to the treatment device memory 24 and to the compression garment 50 memory 75. The process proceeds to step 1008 where treatment device is advanced (the first stepper motor driver controller 27 and the second stepper motor driver controller 28 are advanced). The process proceeds to step 1008 where the next path address is provided to the treatment device until the final address has been reached.

During step 1040, if the treatment device is not in the correct position, the process proceeds to step 1050 and the device treatment motor is deactivated. The process proceeds to step 1052 where the treatment device is repositioned to the last known address identified by the scanner 36 was identical to the location address of the path. The process proceeds to step 1054 where the position of the device is checked. When the treatment device is at the correct address, the process proceeds to step 1045 and the address information is saved to memory. The process proceeds to step 1008, and the treatment device advances to the next path address.

If the last address has been reached in step 1020, the process proceeds to step 1030 where the treatment motor 40 is deactivated. The process proceeds to step 1032 where the first stepper motor driver controller 27 is deactivated and the second stepper motor driver controller 28 is deactivated. The process proceeds to step 1034 where the circuitry can be connected via a communication port to a network 60, which conveys the data to the remote server 67 which can store relevant information for future use. The process proceeds to step 1036 where the user is notified that the treatment has been completed.

The treatment device, regardless of the treatment type (e.g., hair removal, massage) traverses the compression garment 50 using the position detection and path process as described in FIG. 5.

FIG. 6 shows an exemplary track 80 of the autonomous treatment device 20 when removing hair from a particular area of skin. This track merely shows how the autonomous treatment device 20 may traverse the compression garment 50 so that particular areas of the track 80 may be identified and anticipated by the autonomous treatment device 20 in a subsequent application process where the respective moisturizing or massaging process are applied at the appropriate locations in a subsequent process at to this particular area. It is not necessary that the same track 80 be followed. Nevertheless, by following the similar track, it provides an opportunity for the autonomous treatment device 20 to anticipate an upcoming area and apply a lotion or apply a massage skin treatment at the location being approached by the autonomous treatment device 20.

For illustrative purposes, hair removal was mainly described herein. However, the structures and processes described herein are also equally applicable to laser procedures, massage procedures, lotion application procedures, and non-permanent body paint application procedures.

FIG. 7A is a perspective view of an embodiment of the present disclosure wherein a treatment dispenser 1740 being detachably attachable to the autonomous treatment device 20 housing 48. The autonomous treatment device housing 48 is offset from a center of the autonomous treatment device 20 and includes a supply hose receptacle 1729 having a shape to receive a supply hose connector 1739, a spring clamp receptacle 1727 having a shape matched to receive a spring loaded connector 1737, and an electrical receptacle 1725 having a shape to receive an electrical connector 1735.

FIG. 7B is a plane view of an embodiment of the present disclosure wherein a treatment dispenser 1740 is detachably attachable to the autonomous treatment device 20. The treatment dispenser 1740 includes a connection housing 46 being offset from a center of the treatment dispenser 1740 to align with the treatment device housing 48 when connected, the supply hose connector 1739 having a shape for attaching to the supply hose receptacle 1729, the spring loaded connector 1737 having a shape for attaching to the spring clamp receptacle 1727, and the electrical connector 1735 having a shape for attaching to the electrical receptacle 1725. The supply hose connector 1739, the spring loaded connector 1737, and the electrical connector 1735 being housed in the connection housing 46.

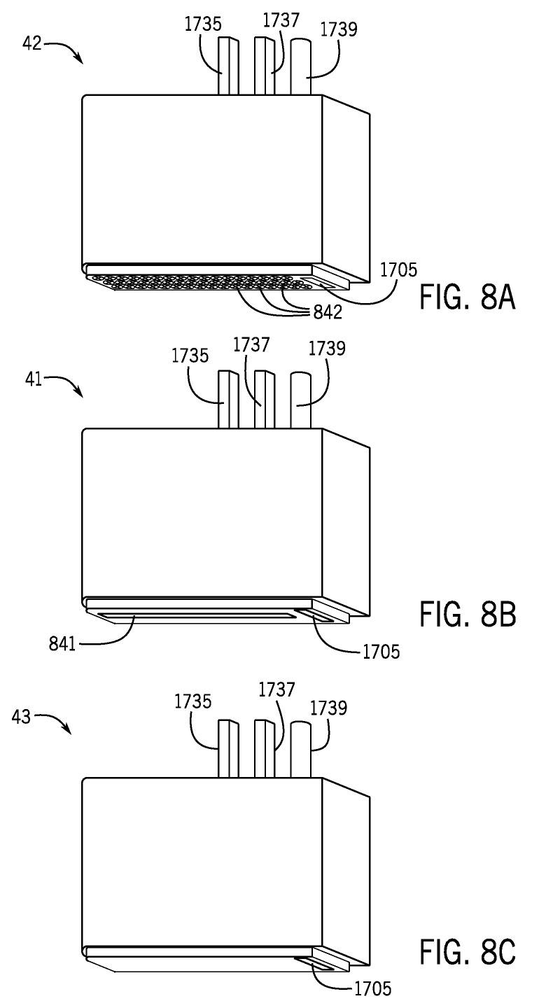

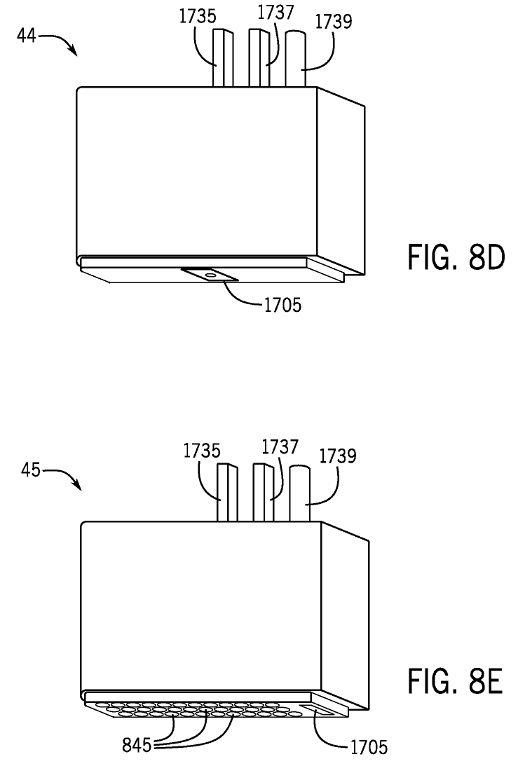

FIG. 8A is a perspective view of an embodiment of the present disclosure of an autonomous hair removal treatment dispenser 42. The hair removal treatment dispenser includes a plurality of rotary blades 842, an exit port 1705, the electrical connector 1735, the spring loaded connector 1737, and the supply hose connector 1739. Hair is cut by the rotary blades 842 and lotion is dispensed through the exit port 1705 as the autonomous treatment device is propelled along the compression garment 20.

FIG. 8B is a perspective view of another embodiment of an autonomous hair removal treatment dispenser 41. The hair removal treatment dispenser 41 includes a laser 841, the exit port 1705, an electrical connector 1735, the spring loaded connector 1737, and the supply hose connector 1739. Hair is removed by the laser 841 as the autonomous treatment device is propelled along the compression garment 20. Skin care lotion is dispensed through the exit port 1705 as the autonomous treatment device is propelled along the compression garment 20.

FIG. 8C is a perspective view of an embodiment of the present disclosure of a moisturizing treatment dispenser 43 that includes the exit port 1705, the electrical connector 1735, the spring loaded connector 1737, and the supply hose connector 1739. Moisturizer is dispensed through the exit port 1705 as the autonomous treatment device is propelled along the compression garment 20.

FIG. 8D is a perspective view of an embodiment of the present disclosure of a non-permanent body paint treatment dispenser 44 that includes the exit port 1705, the electrical connector 1735, the spring loaded connector 1737, and the supply hose connector 1739. Non-permanent body paint is dispensed through the exit port 1705 as the autonomous treatment device is propelled along the compression garment 20.

FIG. 8E is a perspective view of an embodiment of the present disclosure of an autonomous massage treatment dispenser 45. The massage treatment dispenser 45 includes a plurality of massage balls 845, the exit port 1705, the electrical connector 1735, the spring loaded connector 1737, and the supply hose connector 1739. The massage balls 845 rotate and massage oil is dispensed at the exit port 1705 as the autonomous treatment device 20 is propelled along the compression garment.

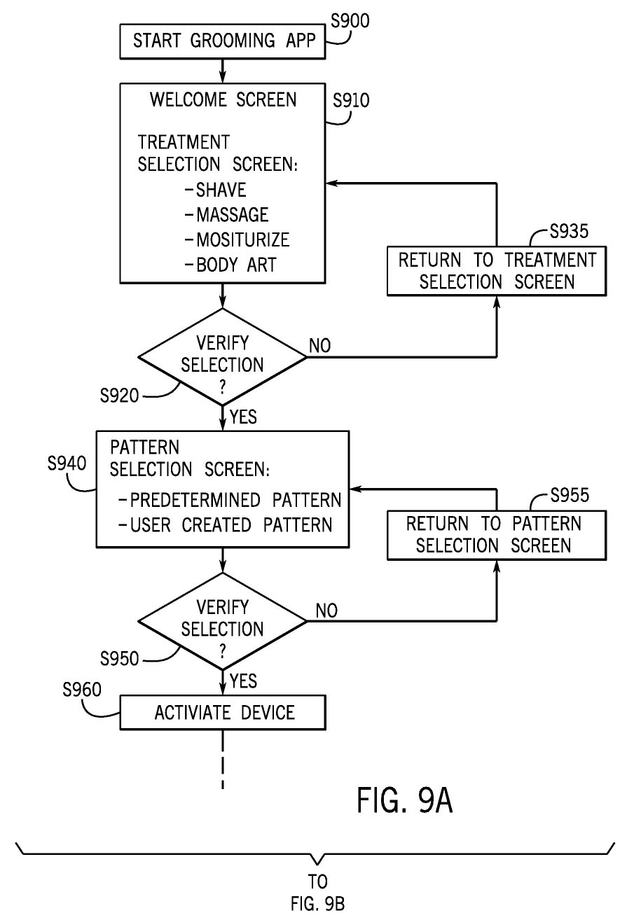

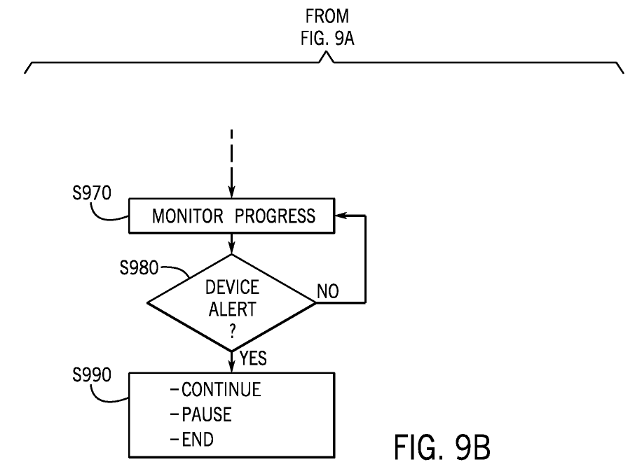

FIGS. 9A and 9B are a Smartphone application flowchart with menu with selection options to control the autonomous treatment system. The process begins in step 900 where the application has been opened. The process proceeds to step 910 where a welcome screen appears and the user selects the treatment to be performed. The process proceeds to step 920 where the user is asked to confirm their selection. If the selection is not correct, the process proceeds to step 935 and the user is returned to the welcome screen step 910. If the selection is correct, the process proceeds to step 940 where the user selects a path for the autonomous treatment device to follow. The process proceeds to step 950 and the user must verify the path selection. If the path selection is correct, the process proceeds to step 960. If the path selection is incorrect, the process proceeds to step 955 and the user is returned to the pattern selection screen of step 940.

Once the correct pattern is selected and verified, the process proceeds to step 960 where the autonomous treatment device is activated. The process proceeds to step 970 where the progress of the device and state of the device are continually monitored along the path. The process proceeds to step 980 where the detection of an anomaly or end of treatment generates and alert to the user. If an anomaly or end of treatment is not detected, the process proceeds to step 970. If an anomaly or end of treatment is detected the process proceeds to step 990 and the user is prompted to take action. The user can continue, pause, or end the process in step 990.

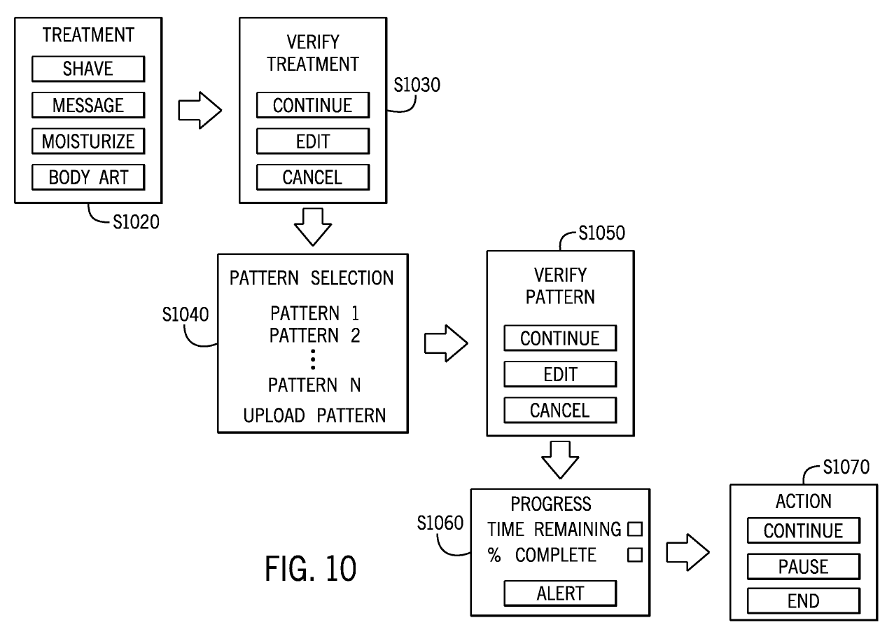

FIG. 10 is the Smartphone application Graphical User Interface. The process begins at Step 1020 where a Welcome screen appears and the user selects a type of treatment (e.g., Shave, Massage, Moisturize, Body Art). Once the type of treatment is selected, the process proceeds to step 1030 where a Treatment Selected must be verified. The user has the option to select Continue, Edit, or Cancel. If the user selects Continue, the process proceeds to step 1040. If the user selects Edit, the process returns to step 1020 and the user is brought back to the Welcome screen to change the type of treatment selected. If the user selects Cancel, the process is cancelled.

At step 1040 a Pattern Selection menu appears. The user selects the pattern from the options provided. The user has an option to select from existing patterns or to upload a pattern of their choosing.

Once the type of pattern is selected, the process proceeds to step 1050 where a Verify Pattern menu appears and the pattern selected must be verified. The user has the option to select Continue, Edit, or Cancel. If the user selects Continue, the process proceeds to step 1060. If the user selects Edit, the process returns to step 1040 and the user is brought back to the Pattern Selection menu to change the pattern selected. If the user selects Cancel, the process is cancelled.

At step 1060 a Progress menu appears. The information provided at this menu includes time remaining in the treatment, percent complete, and if a notification has been detected. The process proceeds to step 1070 once the treatment has been completed or if the system has identified an alert. At step 1070 the ACTION menu appears and the user has the option to select Continue, Pause, or End. If the user selects Continue, the treatment continues. If the user selects Pause, the treatment is paused. If the user selects End, the treatment is terminated.

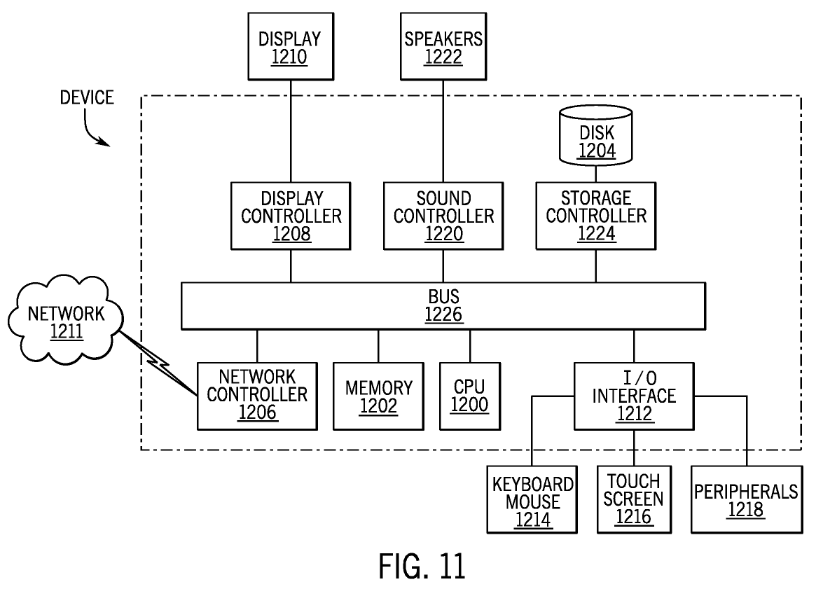

FIG. 11 is a schematic diagram of controller circuitry employed in an exemplary embodiment of a computer-based component of the device, smartphone, or server component of the system. The system includes a CPU 1200 which performs the processes described above/below. The process data and instructions may be stored in memory 1202. These processes and instructions may also be stored on a storage medium disk 1204 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the APGAS system communicates, such as a server or computer.

Further, the claimed advancements may be provided as a utility application, background daemon, or component of an operating system, or combination thereof, executing in conjunction with CPU 1200 and an operating system such as Microsoft Windows 7, UNIX, Solaris, LINUX, Apple MAC-OS and other systems known to those skilled in the art.

The hardware elements in order to achieve the APGAS system may be realized by various circuitry elements, known to those skilled in the art. For example, CPU 1200 may be a Xenon or Core processor from Intel of America or an Opteron processor from AMD of America, or may be other processor types that would be recognized by one of ordinary skill in the art. Alternatively, the CPU 1200 may be implemented on an FPGA, ASIC, PLD or using discrete logic circuits, as one of ordinary skill in the art would recognize. Further, CPU 1200 may be implemented as multiple processors cooperatively working in parallel to perform the instructions of the inventive processes described above.

The system in FIG. 11 also includes a network controller 1206, such as an Intel Ethernet PRO network interface card from Intel Corporation of America, for interfacing with network 1211. As can be appreciated, the network 1211 can be a public network, such as the Internet, or a private network such as an LAN or WAN network, or any combination thereof and can also include PSTN or ISDN sub-networks. The network 1211 can also be wired, such as an Ethernet network, or can be wireless such as a cellular network including EDGE, 3G and 4G wireless cellular systems. The wireless network can also be WiFi, Bluetooth, or any other wireless form of communication that is known.

The system further includes a display controller 1208, such as a NVIDIA GeForce GTX or Quadro graphics adaptor from NVIDIA Corporation of America for interfacing with display 1210, such as a Hewlett Packard HPL2445w LCD monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners, such as an OfficeJet or DeskJet from Hewlett Packard.

A sound controller 1220 is also provided in the system, such as Sound Blaster X-Fi Titanium from Creative, to interface with speakers/microphone 1222 thereby providing sounds and/or music.

The general purpose storage controller 1224 connects the storage medium disk 1204 with communication bus 1226, which may be an ISA, EISA, VESA, PCI, or similar, for interconnecting all of the components of the system. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

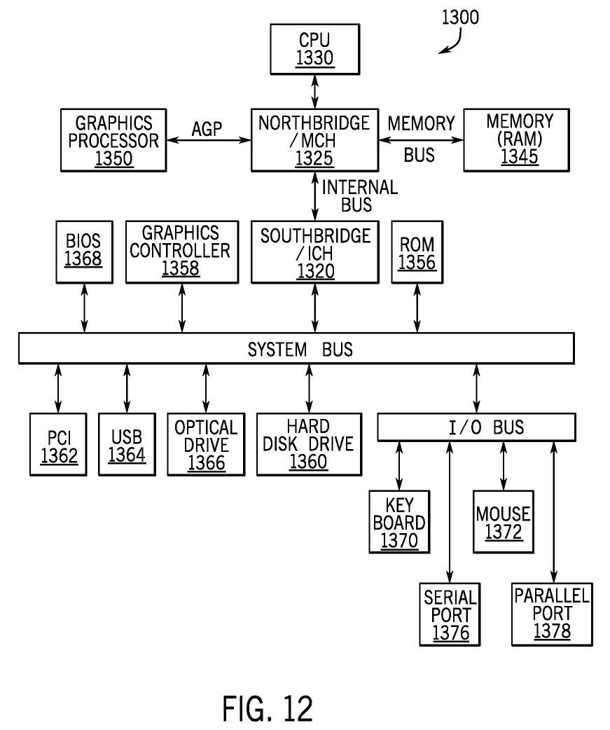

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 12.

FIG. 12 shows a schematic diagram of a data processing system, according to certain embodiments, for performing the control operations of the lawnmower electronics. The data processing system is an example of a computer in which code or instructions implementing the processes of the illustrative embodiments may be located.

In FIG. 12, data processing system 1300 employs a hub architecture including a north bridge and memory controller hub (NB/MCH) 1325 and a south bridge and input/output (I/O) controller hub (SB/ICH) 1320. The central processing unit (CPU) 1330 is connected to NB/MCH 1325. The NB/MCH 1325 also connects to the memory 1345 via a memory bus, and connects to the graphics processor 1350 via an accelerated graphics port (AGP). The NB/MCH 1325 also connects to the SB/ICH 1320 via an internal bus (e.g., a unified media interface or a direct media interface). The CPU Processing unit 1330 may contain one or more processors and even may be implemented using one or more heterogeneous processor systems.

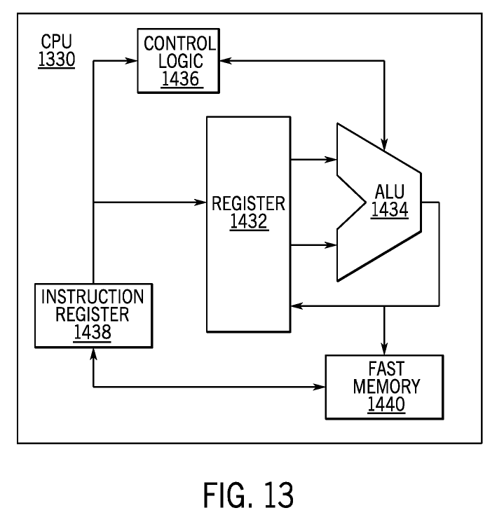

For example, FIG. 13 shows one implementation of CPU 1330. In one implementation, the instruction register 1438 retrieves instructions from the fast memory 1440. At least part of these instructions are fetched from the instruction register 1438 by the control logic 1436 and interpreted according to the instruction set architecture of the CPU 1330. Part of the instructions can also be directed to the register 1432. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 1434 that loads values from the register 1432 and performs logical and mathematical operations on the loaded values according to the instructions. The results from these operations can be feedback into the register and/or stored in the fast memory 1440. According to certain implementations, the instruction set architecture of the CPU 1330 can use a reduced instruction set architecture, a complex instruction set architecture, a vector processor architecture, a very large instruction word architecture. Furthermore, the CPU 1330 can be based on the Von Neuman model or the Harvard model. The CPU 1330 can be a digital signal processor, an FPGA, an ASIC, a PLA, a PLD, or a CPLD. Further, the CPU 1330 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 12, the data processing system 1300 can include that the SB/ICH 1320 is coupled through a system bus to an I/O Bus, a read only memory (ROM) 1356, universal serial bus (USB) port 1364, a flash binary input/output system (BIOS) 1368, and a graphics controller 1358. PCI/PCIe devices can also be coupled to SB/ICH through a PCI bus 1362.

The PCI devices may include, for example, Ethernet adapters, add-in cards, and PC cards for notebook computers. The Hard disk drive 1360 and CD-ROM 1366 can use, for example, an integrated drive electronics (IDE) or serial advanced technology attachment (SATA) interface. In one implementation the I/O bus can include a super I/O (SIO) device.

Further, the hard disk drive (HDD) 1360 and optical drive 1366 can also be coupled to the SB/ICH 1320 through a system bus. In one implementation, a keyboard 1370, a mouse 1372, a parallel port 1378, and a serial port 1376 can be connected to the system bust through the I/O bus. Other peripherals and devices that can be connected to the SB/ICH 1320 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

Obviously, numerous modifications and variations of the present invention are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including and readily discernable variants of the teachings herein, define, in part, the scope of the foregoing claim terminology such that no inventive subject matter is dedicated to the public.

1. A personal grooming apparatus comprising:
a propelled treatment device having at least two continuous track systems that propel the treatment device in a moving direction along a path across a compression garment comprising a plurality of computer addressable warp threads and a plurality of computer addressable weft threads, the plurality of computer addressable warp threads and the plurality of computer addressable and weft threads forming a computer addressable grid with thread intersections at different locations on the compression garment;
a scanner attached to the treatment device and positioned to read an address of a thread intersection that is closest to the scanner;
a non-transitory memory configured to store at least a portion of the plurality of thread intersections of the computer addressable grid; and
a processor configured to record a location of the treatment device in the compression garment.

2. The personal grooming apparatus of claim 1, wherein
the processor is configured to perform location comparison of a stored path to an actual location of the treatment device, to determine if the treatment device is in a correct position with respect to the stored path.

3. The personal grooming apparatus of claim 2 wherein
in a subsequent pass of the treatment device along the stored path, the processor is configured to identify the actual location of the treatment device in a subsequent treatment.

4. The personal grooming apparatus of claim 2, wherein
the scanner is configured to receive an input from the processor regarding the location of the stored path, and use the input to assist in navigating the treatment device to a correct thread intersection.

5. The personal grooming apparatus of claim 1, further comprising
a pulse generator that sends digital pulses containing address information along the plurality of warp threads.

6. The personal grooming apparatus of claim 5, wherein
the plurality of computer addressable weft threads are configured to receive address information from the pulse generator.

7. The personal grooming apparatus of claim 1, wherein
the propelled treatment device comprises an electric razor.

8. The personal grooming apparatus of claim 1, wherein
the propelled treatment device comprises a laser.

9. The personal grooming apparatus of claim 1, wherein
the propelled treatment device comprises at least one massage ball.

10. The personal grooming apparatus of claim 1, wherein
the propelled treatment device comprises a lotion dispenser.

11. The personal grooming apparatus of claim 1, wherein
the propelled treatment device comprises a non-permanent body paint dispenser.

12. The personal grooming apparatus of claim 1, wherein
the propelled treatment device is detachably attachable to the personal grooming apparatus.

13. The personal grooming apparatus of claim 1 further comprising the compression garment, wherein
a shape of the compression garment conforms to a leg.

14. The personal grooming apparatus of claim 1 further comprising the compression garment, wherein
a shape of the compression garment conforms to an arm.

15. The personal grooming apparatus of claim 1 further comprising the compression garment, wherein
a shape of the compression garment conforms to a torso.

16. The personal grooming apparatus of claim 1 further comprising the compression garment, wherein
a shape of the compression garment conforms to a back.

17. The personal grooming apparatus of claim 1 further comprising the compression garment, wherein
a shape of the compression garment conforms to a foot.

18. The personal grooming apparatus of claim 1 further comprising the compression garment, wherein
a shape of the compression garment conforms to a hand.

19. A personal grooming system comprising:
a propelled treatment device having at least two continuous track systems that propel the treatment device in a moving direction along a path across a compression garment comprising a plurality of computer addressable warp threads and a plurality of computer addressable weft threads,
the compression garment;
the plurality of computer addressable warp threads and the plurality of computer addressable and weft threads forming a computer addressable grid with thread intersections at different locations on the compression garment;
a scanner attached to the treatment device and positioned to read an address of a thread intersection that is closest to the scanner;
a non-transitory memory configured to store at least a portion of the plurality of thread intersections of the computer addressable grid; and
a processor configured to record a location of the treatment device in the compression garment.
